(19) United States
(12) Patent Application Publication
(10) Pub. No.: US 2008/0312953 A1
(43) Pub. Date: Dec. 18, 2008

(54) DATABASE DESIGN FOR COLLECTION OF MEDICAL INSTRUMENT PARAMETERS

(75) Inventor: Michael J. Claus, Newport Coast, CA (US)

Correspondence Address: ADVANCED MEDICAL OPTICS, INC., 1700 E. ST. ANDREW PLACE, SANTA ANA, CA, 92705, US

(73) Assignee: Advanced Medical Optics, Inc., Santa Ana, CA (US)

(21) Appl. No.: 11/763,398

(22) Filed: Jun. 14, 2007

(51) Int. Cl. G06Q 50/00

(52) U.S. Cl. 705/2

(57) ABSTRACT

A method and system for maintaining medical items is provided. The system includes a medical database structure, a medical database utility configured to maintain medical database contents by organizing medical information into levels, and a user interface component configured to enable a user to access the medical database utility. The medical database utility provides a user with an ability to access the user's collections of settings in the medical database, the user's collection of settings maintained separately from settings accessible by other users. The method stores medical data items in a database configured with multiple levels of organization, establishes a logical relationship between medical data items at each level of organization, presents a user with available medical system choices at each level of organization, and enables the user to select from among the available medical system choices presented at each level of organization.

### BACKGROUND OF THE-INVENTION

1. Field of the Invention

The present invention relates generally to the art of medical instrument systems, and more specifically to a database and interface utility for use in operating a medical instrument.

2. Description of the Related Art

Today's medical instrument systems, such as medical products or surgical equipment, typically are deployed in operating theater environments shared by multiple operators/users, such as surgeons or other medical personnel. In these environments, a surgeon can select and recall a program from a group of programs, and can alter existing settings to change the stored configuration parameter values. Setting the configuration parameter values allows the operator/user to tailor the behavior of the instrument system for an upcoming medical procedure. Today's medical instrument system programs can provide a wide flexible range of use and typically allow individually operators/users to maintain complex collections of settings, or values, for various configurable parameters called with a specific program for use by a surgeon to instruct control of the machine.

In today's operating theater environments, a precision surgical device, such as a phacoemulsification machine, typically operates or behaves based pursuant to the contents of a program contained therein. A surgeon may set or alter the values for the surgical instrument system, such as configuration parameters, to tailor the behavior of the surgical instrument while performing a specific medical, procedure or for a particular situation. Operating theaters typically support multiple surgeons sharing surgical devices. Each surgeon may individually operate the phacoemulsification machine and may wish to modify the machine's behavior during the medical procedure based on, for example, the desired surgical technique to be employed, the hardness of a cataract identified for removal, and the surgeon's own personal preference. For example, today's machines afford the surgeon ability to individually set vacuum, flow, ultrasound intensity and duration, pulse shape, and other system parameters.

Current medical instrument system designs are commonly found and utilized in a group practice or hospital environment where multiple surgeons share a single system. These systems must save each individual operators/users, e.g. surgeons, specific configuration parameter settings and must be able to recall these settings when selected by a surgeon preparing to utilize the instrument system. The system storage size requirements typically increase as the number of surgeons sharing the machine increases and as the number of surgical techniques supported increases.

Today's designs typically allow settings to be saved with only a single level of organization. Typically, only a small fixed number of different programs can be saved. Each saved program can be given a descriptive name, such as the name of the surgeon who uses those settings, or the name of the surgical technique. Designs realized using one level of organization are limited in the total number of programs and associated configuration parameters that can be stored.

Storage restrictions associated with use of a single level of organization design may constrain the surgeon's flexibility to control the surgical instrument's behavior as desired during an operational procedure. If the number of programs requiring storage becomes large, current single level designs may hinder the surgeon's ability to distinguish a particular program within the entire large set of programs.

A major commercial problem with regard to current designs is that such designs rely on a manual procedure to set or alter each configuration parameter value prior to using the medical instrument. Such designs can require intensive labor to alter or even to set up the machine properly, particularly where different surgeons employ different programs and parameters for use on a single machine. In addition, previous designs do not provide a mechanism allowing one surgeon's programs to be maintained separately from the programs stored by other surgeons.

Thus, today's measurement system designers are faced with a difficult and complex implementation challenge to insure a surgeon can easily modify, save, recall, and put into use as needed a programs complex collection of settings for surgical instrument configuration parameters to provide the desired control and feedback of the medical instrument.

Based on the foregoing, it would be advantageous to provide a user interface database utility for use in medical instrument systems that overcomes the foregoing drawbacks present in previously known designs used in the control and operation of surgical instruments.

### SUMMARY OF THE INVENTION

According to one aspect of the present design, there is provided a method for maintaining collections of medical systems settings. The method comprises storing medical system programs and all associated medical configuration parameter values in a database configured with::multiple levels of organization, each level of organization comprising medical data items, establishing a logical relationship between medical data items at each level of organization, presenting a user with available medical system choices at each level of organization, and enabling the user to select a particular medical program from the stored medical programs from among the available medical system choices presented at each level of organization.

According to a second aspect of the current design, there is presented a system for maintaining medical items, the system configured for use on a general purpose computer system. The system comprises a medical database structure configured to maintain medical items at multiple levels of organization, a medical database utility configured to maintain medical database contents by organizing medical information into levels presentable to users with information at different levels having similar characteristics but accessible only to predetermined users, and a user interface component configured to enable a user to access the medical database utility. The medical database utility provides the user with an ability to access the user's collections of settings in the medical database, the user's collection of settings maintained separately from settings accessible by other users.

These and other advantages of the present invention will become apparent to those skilled in the art from the following detailed description of the invention and the accompanying drawings.

### BRIEF DESCRIPTION OF THE DRAWINGS

The present invention is illustrated by way of example, and not by way of limitation, in the figures of the accompanying drawings in which:

FIG. 1 is a functional block diagram of a phacoemulsification system that may be-employed in accordance with an aspect of the present invention;

FIG. 2 illustrates a layout for storing data and programs in the multiple-level database structure in accordance with an aspect the present design;

FIG. 3 is a flow chart illustrating a database utility query/response mechanism for navigating the multiple-level database in accordance with an aspect of the present invention; and

FIG. 4 is a flow chart illustrating a database utility query/response mechanism for navigating the multi-level database file system in accordance with another aspect of the present invention.

### DETAILED DESCRIPTION OF THE INVENTION

The following description and the drawings illustrate specific embodiments sufficiently to enable those skilled in the art to practice the system and method described. Other embodiments may incorporate structural, logical, process and other changes. Examples merely typify possible variations. Individual components and functions are generally optional unless explicitly required, and the sequence of operations may vary. Portions and features of some embodiments may be included in or substituted for those of others.

The present design is directed to maintaining relatively large complex collections of system configuration parameter settings organized according to individual operators/users and a means to save, recall and alter those parameters as desired by the operators/users of a safety critical system. However, the present design is not limited to a fixed number of levels of organization and may be increased or decreased depending on the granularity desired or the total number of data items to be organized. In addition, the present design is not limited to a fixed logical relationship between data items at any level of organization. Examples may include, but are not limited to, individual operator/users of a surgical instrument system who desire to adjust the configuration parameter values sufficient to tailor the behavior of the surgical instrument system when used during a particular medical procedure.

The present design provides an apparatus and method for a database configured in a hierarchical tree structure, where individual programs occupy the leaf nodes and the folders occupy the branch nodes, and arranged to save data and information using multiple levels of organization. The present design may provide individual operators or users a mechanism to easily organizing and maintaining a very large number of programs and associated configuration parameter values in a logical, efficient, and intuitive manner. The apparatus and method may facilitate an individual operators/users ability to rapidly distinguish any particular program from the entire large set of stored programs.

In short, the present design apparatus and method may be used to precisely configure a medical instrument system over its entire operational range for a given procedure or set of procedures indicated for a particular patient case or condition. The apparatus and method may provide a quick, easy to use, and reliable mechanism for saving, browsing, and recalling any individual program and flexible enough to allow the setting of configuration parameter values of a wide variety of systems, including but not limited to medical instrument systems.

### SYSTEM EXAMPLE

While the present design may be used in various environments and applications, it will be discussed herein with a particular emphasis on a medical or hospital environment, where a surgeon or health care practitioner performs. For example, one embodiment of the present design is a phacoemulsification surgical system that comprises an independent graphical user interface (GUI) host module, an instrument host module, a GUI device, and a controller module, such as a foot switch, to control the surgical system.

It is to be understood that any type of system having a large number of configuration parameter values to be set, or more specifically systems exhibiting cumbersome and time-consuming activities:to adjust any parameter value to the desired setting prior to using the system, may benefit from the design presented herein, and such a design is not limited to a phacoemulsification system or even a medical system. The present design may be implemented in, for example, systems including but not limited to phacoemulsification-vitrectomy systems, vitrectomy systems, dental systems, heart-lung surgical devices, industrial applications, communication network systems, access control systems, fire control/guidance devices, and aerospace applications.

The present design may employ various interface mechanisms to alter the database contents of the surgical, instrument, such as via a GUI device, or other subsystem, it will be discussed herein with a particular emphasis on saving, recalling, and altering parameter values stored in the instruments database via a graphical user interface. The user interface device may include but is not limited to a touch screen monitor, mouse, keypad, foot pedal switch, and/or a computer monitor. The present design is intended to provide a basic user access or interface mechanism for viewing and, altering a large number of configuration parameter values stored in a database file system that.:affect the behavior of the surgical instrument.

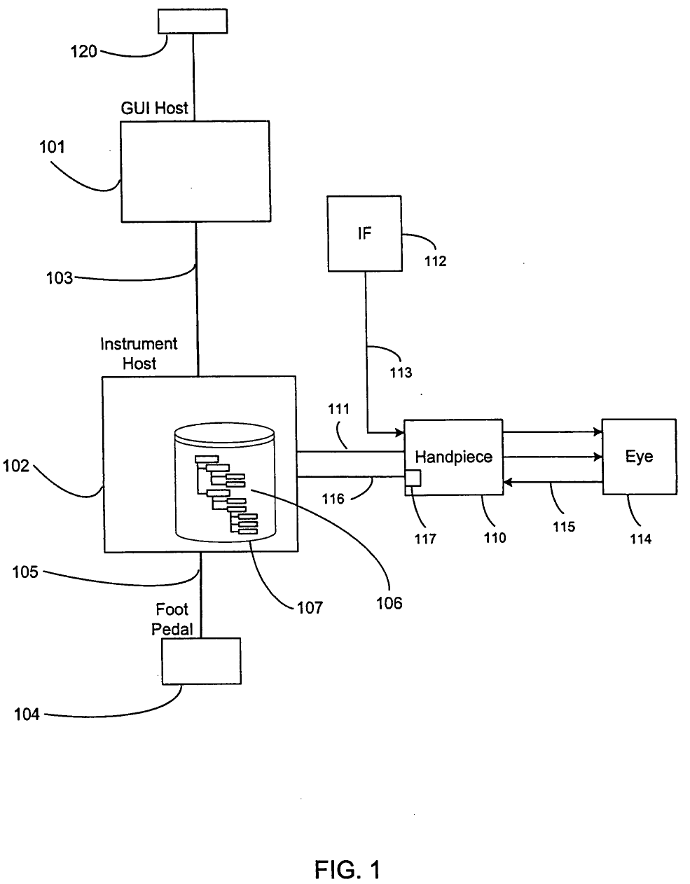

FIG. 1 illustrates a phacoemulsification/vitrectomy system in a functional block diagram to show the components and interfaces for a safety critical medical instrument system that may be employed in accordance with an aspect of the present invention. A serial communication cable 103 connects GUI host 101 module and instrument host 102 module for the purposes of controlling the surgical instrument host 102 by the GUI host 101. A GUI device 120 is connected to GUI host 101 module for displaying information and to provide a mechanism for operator/user input. Although shown connected to the GUI host 101 module, GUI device 120 may be connected or realized on any other subsystem (not shown) that could accommodate such a display/input interaction device. A foot pedal 104 switch module may transmit control signals relating internal physical and virtual switch position information as input to the instrument host 102 over serial communications cable 105. Instrument host 102 may provide a database file system 106 for storing configuration parameter values, programs, and other data saved in storage device 107. In addition, the database file system 106 may be realized on the GUI host 101 or any other subsystem (not shown) that could accommodate such a file system.

The phacoemulsification/vitrectomy system has a handpiece. 110 that includes a needle and electrical means, typically a piezoelectric crystal, for ultrasonically vibrating the needle. The instrument host 102 supplies power on line 111 to a phacoemulsification/vitrectomy handpiece 110. An irrigation fluid source 112 can be fluidly coupled to handpiece 110 through line 113. The irrigation fluid and ultrasonic power are applied by handpiece 110 to a patient's eye, or affected area or region, indicated diagrammatically by block 114. Alternatively, the irrigation source may be routed to the eye 114 through a separate pathway independent of the handpiece. Aspiration is provided to eye 114 by the instrument host 102 pump (not shown), such as a peristaltic pump, through lines 115 and 116. A switch 117 disposed on the handpiece 110 may be utilized as a means for enabling a surgeon/operator to select an amplitude of electrical pulses to the handpiece via the instrument host and GUI host. Any suitable input means, such as for example, a foot pedal 104 switch may be utilized in lieu of the switch 117.

### Database File System Structure

The present design database file system structure may maintain relatively large collections of settings for system configuration parameters that are organized according to the individual operators/users. In addition, the present designs apparatus may enable operators/users to-save, recall, and alter the stored configuration parameters as needed. The database file system structure may provide a means for maintaining and storing configuration parameter values, available for use by an associated program to control the behavior of the surgical instrument within a safety critical system, will be described. The database file system is illustrated in FIG. 1 as residing within the instrument host 102 module, however the file system may reside within the GUI host 101 module, other subsystems, or realized using external devices and/or software.

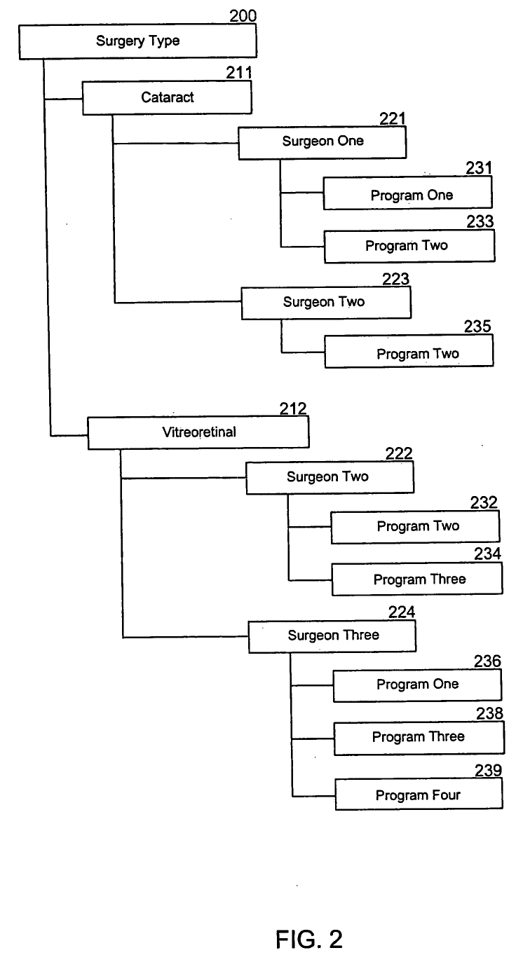

FIG. 2 is a block diagram illustrating the present design database file system apparatus and method employing a hierarchical tree structure arranged in multiple levels of organization configured to save, recall, and alter collections of settings representing a large number of surgical instrument system configuration parameter values in accordance with the present design. FIG. 2 illustrates a three-level of organization database file system layout for storing data and programs in accordance with an aspect of the present design.

The surgical instrument system database structure illustrated in FIG. 2 may organize and store the instrument system configuration parameter values and programs in database file system 106. The top organizational level may involve surgery type at 211 and 212, where the second organizational level may involve surgeon name at 221, 222, 223, and 224. The third organizational level may involve program name at 231, 232, 233, 234, 235, 236, 238 and 239. FIG. 2 illustrates an example of the present design database system configured to store two surgery types, Cataract at 211 and Vitreoretinal at 212. The database example in FIG. 2 illustrates the database arranged to support surgeon one at 221 able to select either program one at 231 or program two at 233 from the set of stored programs for use in performing a cataract surgery. Alternatively, the database example in FIG. 2 illustrates the database arranged to support surgeon two at point 223 able to Select program two at point 235 from the set of stored programs for use in performing a cataract surgery. In addition, FIG. 2 illustrates the database arranged to support surgeon two at point 222 able to select either program two at point 232, or program three at 234 from the set of stored programs for use in performing a Vitreoretinal surgery. Alternatively, the database example in FIG. 2 illustrates the database arranged to support surgeon three at point 224 able to select program one at 236, program three at point 238, or program four at point 239 from the set of stored programs for use in performing a vitreoretinal surgery.

The present design may establish a logical relationship between a higher level of the organization (i.e. surgeons name) and programs stored at lower levels in the organization (i.e. program name) for the purposes of populating the same values for a sub-set of configuration parameters consistently across all programs stored for a particular operator/user. For example, various stored programs may employ a large group of configuration parameters associated with controlling the foot pedal. However, it is extremely unlikely that a particular operator/user would desire to configure the foot pedal differently for each of their stored programs. In this example, the present design may be arranged to allow the operator/user to alter their foot pedal parameter values at the surgeon name level once, in lieu of altering values for each program stored in the program name level of organization. This aspect of the present design may allow operator/user to set values for foot pedal configuration parameters at one time, at the surgeon level of organization, and the database file system populates all programs associated with the surgeons name with these values. In this arrangement, if the surgeon desires to alter their foot pedal value(s) at a later time, they only need to alter the setting once at the surgeon name level of organization and the present design may apply the altered setting(s) to all of the surgeons stored programs. This aspect of establishing logical relationship between a higher level and lower levels of organization may facilitate operators/users to efficiently configure the same configuration parameters across a large number of programs and may improve quality by accurately populating all applicable stored programs with the same values.

Although three-levels of organization and are shown in FIG. 2 as surgery type, surgeons name, and program name, the present design is not limited to a fixed number of levels of organization and may be arbitrarily increased or decreased depending on the granularity desired or the total number of data items to be organized. The present design is not limited to the fixed logical relationships illustrated in FIG. 2, and may establish logical relationships between data items at any level of organization. The present design may allow the operator/user to determine the appropriate number of levels of organization and the relationship of the data items at each level. For example, the database may be organized with four levels of organization: Surgery type, Surgeon name, surgical technique, and program name. Moreover, the present design may be organized with four levels of organization, with a different set of relationships, for example, Surgical Ability, Cataract Density, Disease State, Program name or other set of relationships as needed.

### Database Utility

The systems database utility may use a database interface mechanism to efficiently enable surgeons and other medical professionals to access medical system instrument programs stored in a multi-level database. The database utility may present the medical instrument operator with sets of choices and may logically narrow the choice selection according to the organization hierarchy prescribed by the database in accordance with the present design. The present design's database interface mechanism may present a list of available choices where the user may select his desired choice to navigate or traverse the contents of the system database. At each level of the organizational hierarchy, the present design may restrict the list of presented choices to reflect the set of choices made at the previous levels.

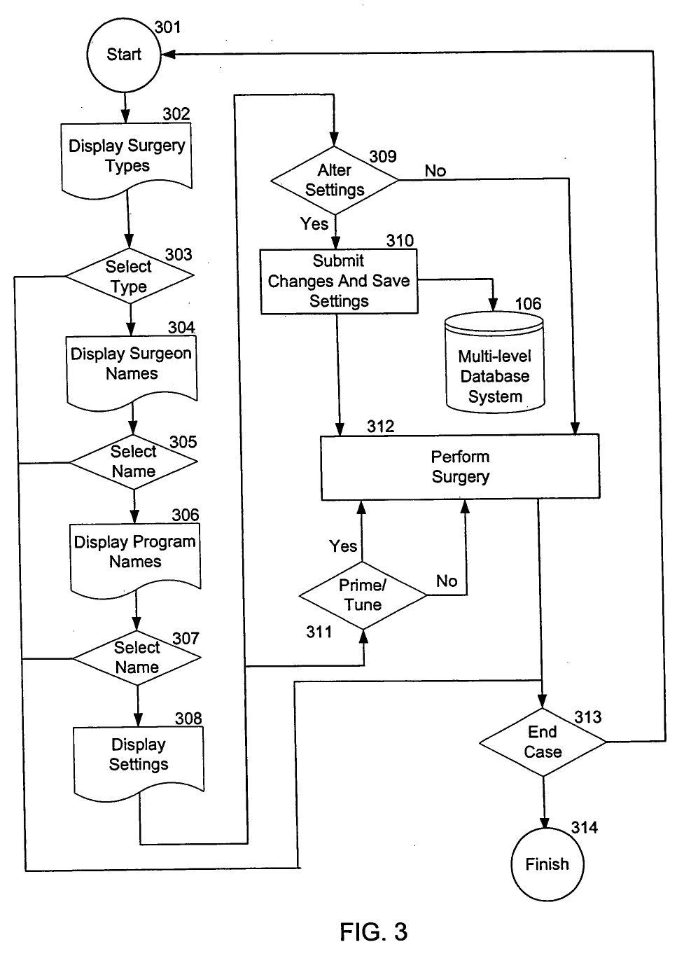

FIG. 3 is a flow chart illustrating a UI database utility query/response mechanism for navigating the multi-level database file system in accordance with an aspect of the present invention. FIG. 3 illustrates one example of operation of the database utility user interface (UI) and may employ a graphical user interface (GUI) device 120 for interaction with such a database file system. This particular embodiment may allow the operator/user to access her desired surgical program quickly and to change or alter configuration parameter values associated with the selected program, thus tailoring the medical instrument's behavior while conducting the medical procedure.

In this configuration, the surgeon may start the database utility UI at point 301. The database utility may present the available surgery types to the GUI device 120 display at point 302. The operator/user may select their name from the list of displayed names appropriate or desired surgery type at point 303. The database utility may present the surgeon names available to access programs associated with the surgery type selected to the GUI device 120 display at point 304. The operator/user may select their name at point 305. The database utility may present the available program names, based on the previously selected surgery type and surgeon name, to the GUI device 120 display at point 306. The operator/user may select the desired program by name at point 307. The database utility may present the configuration parameter settings, associated with the program selected, to the GUI device 120 display at point 308. At this point the operator/user has efficiently traversed the database system to access their desired program, from a large number of programs, and may be positioned to alter or adjust each configuration parameter setting to their desired value prior to using the medical instrument.

At point 309, the individual operator/user may select to alter a program's collection of settings, previously saved in the database system, applicable to the selected program. Selecting ‘yes’ at point 309 may enable the operator/user to enter modifications to the current-settings and submit and save, at point 310, the modified setting in the multi-level database file system 106 prior to performing the required medical procedure.

Alternatively, altering the collection of settings is optional, as the operator/user may be satisfied with the collection of settings displayed at point 308. The operator/user may select ‘yes,’ at 311 to prime/tune the medical instrument prior to operational use. Priming is optional, where priming comprises providing a pressure level or gas to a chamber or area within the device, as the system may already be primed. The primed medical instrument system may now be readied for use at point 312. Priming is a generally known procedure that places fluid within, appropriate portions of the device and readies the device for operation.

When the operator/user has completed the medical procedure they may select end case at point 313 to halt the program and may exit the system when finished at point 314. Alternatively, the operator/user may desire to select another program after ending the case at point 313. In this arrangement, the database utility UI may return to the starting point at point 301 and present the surgery types at point 302 for display on the GUI device 120.

For example, referring back to FIG. 2, the operator/user may select ‘Cataract’ as the type of surgery at the first hierarchical level. The present design may present a list of surgeon names in accordance with the database contents at the second hierarchical level. In this example, the system presents surgeon one and surgeon two as available setting options. At this point, the operator/user may be presented with and select ‘Surgeon One’ from the list of surgeon names presented by the database access mechanism in accordance with the present design. The system presents surgeon one with a list of available program names for selection. In this example, program one and program two are presented to surgeon one for selection. Therefore, after choosing the Cataract surgery type, only surgeon names that are associated with cataract surgery programs are shown. Once a particular surgeon name is selected, the database interface mechanism displays only those program names associated with both cataract surgery and the selected surgeon name.

As may be appreciated from FIGS. 1 and 2, the present design's database structure in combination with the database utilities query/response interface mechanism may allow a user to quickly choose the program they desire to employ in an upcoming procedure by efficiently sorting through the entire large set of instrument system programs.

The system may use the present design's organizational structure to eliminate steps in the selection process depending on the data found in the database. If no programs in the database are associated with Vitreoretinal surgery, the database utility may bypass the selection process requiring the operator/user to choose between Cataract and Vitreoretinal surgery types. In this arrangement, the system may assume that the Cataract surgery type is selected. In addition, if there is only one program associated with any Surgeons Name in the database, then the system may assume that the program is selected when the Surgeon Name is selected, and the system may bypass the step of choosing the program name.

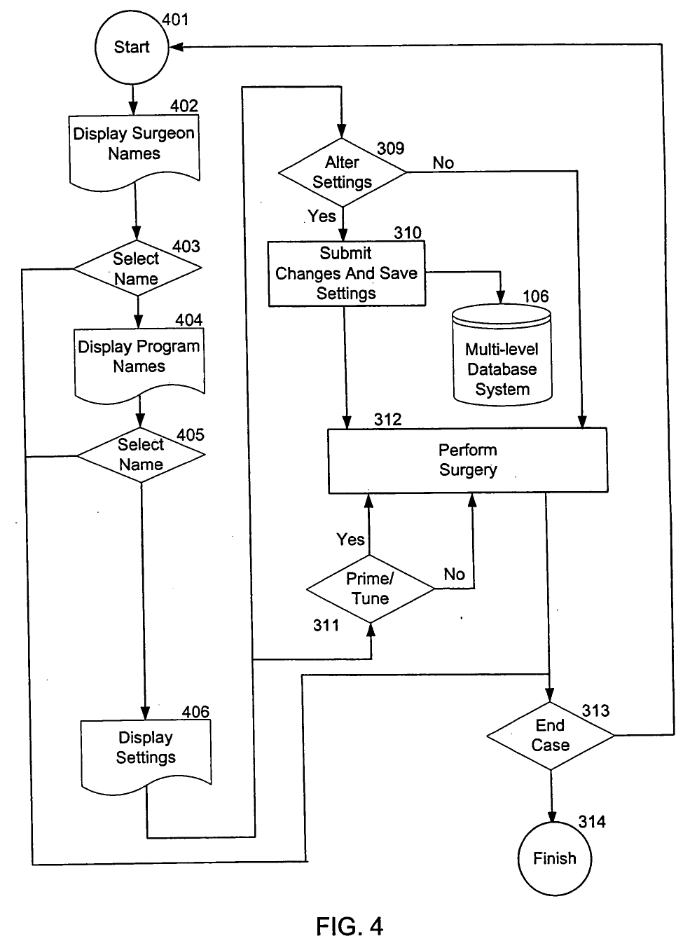

FIG. 4 is a flow chart illustrating a database utility query/response mechanism for navigating the multi-level database file system in accordance with another aspect of the present invention. Certain operating environments may be better served by enabling an operator/user to make choices associated with more than one level of organization simultaneous. For example, depending on the number of nodes at each level, it may be desirable to present all the available choices for more than one level of organization at a particular point in the selection process. In this arrangement, the present design may present all of a particular surgeons program names associated with both Cataract surgeries and Vitreoretinal surgeries simultaneously.

In this embodiment, the surgeon may start the database utility UI at point 401. The database utility may present the, available surgery names to the GUI device 120 display at point 402. The operator/user may select their name from the list of displayed names appropriate or desired surgery type at point 403. The database utility may present the program names available associated with the surgeon name selected to the GUI device 120 display at point 404. At this point, the system may present program names including both Cataract and Vitreoretinal surgeries simultaneously. In this example, the system may enable the operator/user to choose both surgery type and program name, being organizational levels two and three respectively, simultaneously. In this configuration, the system may allow operators/users to make choices associated with more than one level of organization at one time.

The operator/user may select the desired program name at point 405. The database utility UI may present the available configuration parameter values, based on the previously selected program name, to the GUI device 120 display at point 406. At this point the operator/user has efficiently traversed the database system to access their desired program, from a large number of programs, and may be positioned to falter or adjust each configuration parameter setting to their desired value prior to using the medical instrument, as previously described with respect to FIG. 3.

The database utility mechanism for selection at any particular level of organization may not be via buttons or other user interface elements on the GUI device 120 display screen. The system may be configured to restrict the available selections to only those programs which can be correctly utilized by using the accessories, e.g. tubing packs, handpieces, or other peripheral items, that are actually connected to the medical instrument system at any given time. For example, if the phacoemulsification system utilizes two different fluidic cassettes, at point 112 in FIG. 1, certain programs may require one or the other of these two cassettes. In this arrangement, the system only provides programs for selection to those in the database that can correctly use the currently installed tubing cassette.

The design presented herein and the specific aspects illustrated are meant not to be limiting, but may include alternate components while still incorporating the teachings and benefits of the invention. While the invention has thus been described in connection with specific embodiments thereof, it will be understood that the invention is capable of further modifications. This application is intended to cover any variations, uses or adaptations of the invention following, in general,!the principles-of the invention, and including such departures from the present disclosure as come within known and customary practice within the art to which the invention pertains.

The foregoing description of specific embodiments reveals the general nature of the disclosure sufficiently that others can, by applying current knowledge, readily modify and/or adapt the system and method for various applications without departing from the general concept. Therefore, such adaptations and modifications are within the meaning and range of equivalents of the disclosed embodiments. The phraseology or terminology employed herein is for the purpose of description and not of limitation.

What is claimed is:

1. A method for maintaining collections of medical systems settings, comprising:
storing medical system programs and all associated medical configuration parameter values in a database configured with multiple levels of organization, each level of organization comprising medical data items;
establishing a logical relationship between medical data items at each level of, organization;
presenting a user with available medical system choices at each level of organization; and
enabling the user to select a particular medical program from the stored medical programs from among the available medical system choices presented at each level of organization.

2. The method of claim 1, further comprising enabling the user to save, recall, alter, and use medical data items associated with the user separately from medical data items maintained on behalf of other users.

3. The method of claim 1, wherein each organizational level is arranged in a hierarchical tree structure.

4. The method of claim 1, wherein establishing comprises organizing collections of medical settings organized according to individual users.

5. The method of claim 1, wherein presenting further comprises offering the user a set of available option choices at each level of the organizational hierarchy restricted to reflect previously made option choices.

6. The method of claim 1, wherein the multiple levels of organization have a quantity of levels that may be arbitrarily altered based on one from a group comprising:
a level of granularity desired; and
a total number of medical data items organized.

7. The method of claim 1, wherein logical relationships between medical data items at any level of organization are arbitrary.

8. The method of claim 1, wherein presenting further comprises providing the user with a set of available options for more than one level of organization simultaneously.

9. A method for using medical data, comprising:
presenting a user with a set of available option choices, at each organizational level of a multiple level of organization medical database, wherein each organizational level is arranged in a hierarchical tree structure;
enabling the user to select option choices at each organizational level of the medical database that narrows selection options according to the organizational hierarchy; and
enabling the user to alter and submit medical data changes to the multiple level of organization medical database.

10. The method of claim 9, wherein presenting further comprises providing the user with only those data items associated with selected option choices at each level of organization.

11. The method of claim 9, wherein presenting further comprises providing the user with a set of available option choices at each level of the organizational hierarchy restricted to reflect previously made option choices.

12. The method of claim 9, wherein presenting comprises simultaneously providing the user with a set of available option choices for more than one level of organization at a particular point in the selection process.

13. A system for maintaining medical: items, the system configured for use on a general purpose computer system, the system comprising:
a medical database structure configured to maintain medical items at multiple levels of organization;
a medical database utility configured to maintain medical database contents by organizing medical information into levels presentable to users with information at different levels having similar characteristics but accessible only to predetermined users; and
a user interface component configured to enable a user to access the medical database utility;
wherein the medical database utility provides the user with an ability to access the user's collections of settings in the medical database, the user's collection of settings maintained separately from settings accessible by other users.

14. The system of claim 13, wherein the medical database structure has multiple levels of organization arranged in a hierarchical tree structure.

15. The system of claim 13, wherein the medical database contents comprise associations between medical computer programs and individual users.

16. The system of claim 13, wherein the system is configured to offer the user a set of available option choices at each level of the organizational hierarchy restricted to reflect previously made option choices.

17. The system of claim 14, wherein, the multiple levels of organization have a quantity of levels that may be arbitrarily altered based on one from a group comprising:
a level of granularity desired; and
a total number of medical data items organized.

18. The system of claim 13, wherein logical relationships between medical items at any level of organization are arbitrary.

19. The system of claim 13, wherein the medical database utility and the user interface component operate to provide the user with a set of available options for more than one level of organization simultaneously.
